(19) United States
(12) Patent Application Publication
(10) Pub. No.: US 2026/0162144 A1
(43) Pub. Date: Jun. 11, 2026

(54) Computer-Implemented System and Method for Managing and Optimizing a Portfolio of Digital Advertisements Across Multiple Platforms and Channels

(71) Applicant: Robert Diab, Middletown, DE (US)

(72) Inventor: Robert Diab, Middletown, DE (US)

(21) Appl. No.: 18/969,352

(22) Filed: Dec. 5, 2024

(51) Int. Cl. G06Q 30/0242; G06Q 30/0241

(52) U.S. Cl. CPC G06Q 30/0243; G06Q 30/0249; G06Q 30/0277

(57) ABSTRACT

A computer-implemented system and method for managing and optimizing a portfolio of digital advertisements across multiple platforms and channels. The system receives platform performance data and website analytics data for a plurality of advertisements. A normalized score from 0 to 100 is computed for each advertisement based on percentile ranks of performance metrics relative to a peer group. The normalized scores define an ad portfolio and determine the relative performance of each advertisement therein. Actionable recommendations are provided for optimizing the portfolio, including identifying low-performing ads, suggesting budget allocation adjustments, and aggregating scores by various attributes. The invention enables comprehensive evaluation and optimization of digital advertising performance in a privacy-centric environment with fragmented customer journey tracking.

### BACKGROUND

The present invention relates generally to digital marketing and advertising. More specifically, the invention relates to systems and methods for optimizing digital advertising performance across multiple platforms and digital channels.

Marketing attribution is crucial for businesses to understand which marketing efforts drive results and make informed budget allocation decisions. Traditionally, marketing attribution involved assigning credit from a conversion to the marketing channels and campaigns that led to that conversion by tracking the complete customer journey. However, this approach has become increasingly difficult due to privacy measures that fragment customer journey tracking mostly due to cookie and tracking code blockage.

Advertising platforms like Google Ads and Facebook Ads are limited in their ability to advertise towards the marketing target (e.g. conversion) due to low quality tracking data. While some companies claim to have solved tracking in a cookie less world, marketers increasingly struggle to reliably understand true cost-per-order (CPO), return on ad spend (ROAS), revenue, and conversions at a granular level. Incomplete website or storefront feedback from paid clicks into ad platforms affects optimization, targeting, and the ability to efficiently select successful ads and scale ad spend.

Some existing solutions attempt to replace retrospective attribution with predictive models that compute historical performance to make predictions on future buying behavior. However, these models typically aim to identify individual high performing ads based on customer journey models rather than optimizing performance across an entire ad portfolio.

Other systems, like that described in U.S. Pat. No. 7,668,832, use location information to improve ad targeting and relevance scoring. And US Patent Application No. 20080065479 discloses optimizing online ad auctions using linear programming techniques. While helpful for aspects like geo-targeting and bidding, these systems do not provide a comprehensive solution for evaluating and optimizing overall digital ad performance across channels like Google Ads or Facebook Ads, campaigns, and ad sets.

There remains a need for a system that allows digital marketers to reliably measure on equal footings and optimize the relative performance of their advertising efforts in a fragmented, privacy-centric environment. The present invention aims to solve these and other deficiencies in the existing art.

### SUMMARY

The present invention addresses the need for a comprehensive system to evaluate marketing assets like ads or creatives and optimize digital advertising performance across multiple digital platforms and channels in a privacy-centric environment. The invention provides a computer-implemented method and system for managing and optimizing a portfolio of digital advertisements.

In one aspect, the invention involves receiving platform performance data for a plurality of advertisements from one or more advertising platforms, including metrics such as cost-per-mille (CPM), click-through-rate (CTR), cost-per-click (CPC), and cost-per-result (CPR). Website performance data is also received from a website analytics platform, including metrics like cost-per-page-view (CPPV), cost-per-session (CPS), cost-per-add-to-cart (CPATC), bounce rate, and average session duration.

A key feature of the invention is computing a normalized score for each advertisement on a scale from 0 to 100 based on combined platform and website performance data. This involves determining percentile ranks for each performance metric relative to a peer group of advertisements and calculating a weighted average of the percentile ranks. The weights can be predetermined based on each metric's predictive contribution to a conversion.

The normalized scores are used to define a portfolio of advertisements, which is based on a lookback window of time. The relative performance of each advertisement in the portfolio is determined by comparing its normalized score to the peer group within the portfolio. The peer group is defined by the selected aggregation level such as country or landing-page.

The invention then provides actionable recommendations for optimizing the ad portfolio based on the relative performance analysis. These can include identifying low-performing ads to remove, evaluating overall portfolio performance against benchmarks, suggesting budget allocation adjustments between ads, and aggregating scores and recommendations by various attributes like campaign, ad set, creative, region, or landing page depending on the selected peer group.

By considering both advertising platform and website analytics data, the invention provides a more comprehensive evaluation of digital ad performance compared to existing solutions, in particular it puts the ad performance on equal footings. The computed normalized scores enable relative comparisons between ads across different platforms, campaigns and ad sets. And the portfolio-based approach and optimization recommendations allow marketers to make impactful improvements to their overall digital advertising strategy, rather than just identifying individual high-performing ads on each platform separately.

These and other aspects of the invention provide a reliable and efficient way for businesses to measure and optimize their digital advertising efforts despite the challenges posed by increasing data privacy measures and fragmented customer journey tracking. The technical advantages offered by the invention meaningfully improve upon existing marketing attribution and optimization systems.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates an exemplary system architecture for managing and optimizing a portfolio of digital advertisements.

FIG. 2 depicts a flowchart illustrating the overall method for managing and optimizing a portfolio of digital advertisements.

FIG. 3 illustrates an example visualization comparing the normalized performance scores of advertisements in a defined portfolio against a peer group.

FIG. 4 graphically represents the computation of CTR scores over a look-back window.

FIG. 5 illustrates the relationship between Ad Account Spend and Ad Account Score for various stores.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein, can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

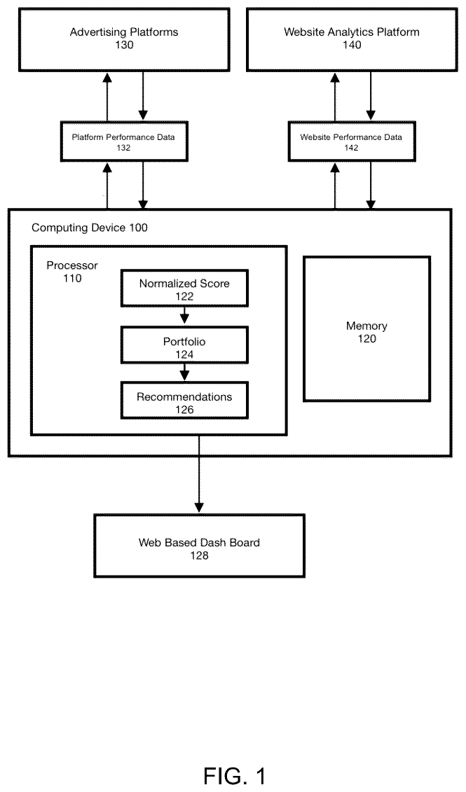

FIG. 1 illustrates an exemplary system architecture for managing and optimizing a portfolio of digital advertisements in accordance with the present disclosure. The system includes a computing system 100 comprising a processor 110, such as an Intel Xeon or AMD Ryzen processor, and a memory 120, such as DDR4 RAM. The memory 120 stores instructions, such as a machine learning script implemented using Python, TensorFlow, and Keras libraries, that, when executed by the processor 110, cause the computing system 100 to perform the operations of the advertising optimization method.

The computing system 100 interfaces with one or more advertising platforms 130, such as Google Ads or Facebook Ads, via their respective APIs to receive platform performance data 132 for a plurality of advertisements. The platform performance data 132 comprises metrics such as cost-per-mille (CPM), click-through-rate (CTR), cost-per-click (CPC), and optionally cost-per-result (CPR) for each advertisement.

Additionally, the computing system 100 interfaces with a website analytics platform 140, such as Google Analytics or Adobe Analytics, to receive website performance data 142 for the advertisements. The website performance data 142 includes metrics like page-views, sessions, add-to-carts, and bounce rate and session duration.

The processor 110 executes the stored instructions, utilizing libraries such as NumPy and Pandas for data manipulation, to compute normalized scores 122 for each advertisement based on the received platform and website performance data. The normalized scores are on a scale from 0 to 100. The processor 110 then defines a portfolio of advertisements 124 based on the normalized scores, optionally stored in a NoSQL database, such as MongoDB to store and query the portfolio data. The processor 110 compares the normalized score of each ad in the portfolio to a peer group of ads to determine relative performance, using statistical analysis techniques such as t-tests or ANOVA.

It then generates optimization recommendations 126, displayed on a web-based dashboard 128 built with a framework like React or Angular, based on the relative performance analysis. The portfolio definition 124 can optionally be based on variables comprising a configurable lookback window of time and peer groups such as certain countries.

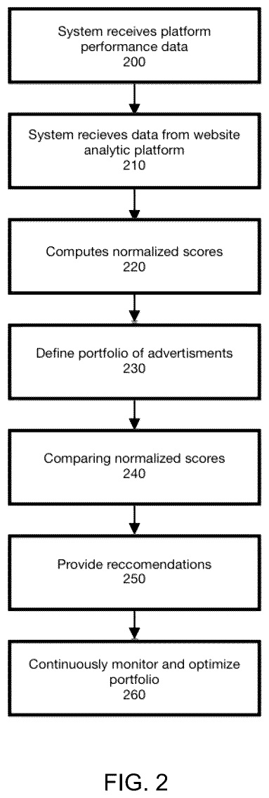

FIG. 2 depicts a flowchart illustrating the overall method for managing and optimizing a portfolio of digital advertisements according to the present disclosure. The method begins at step 200, where the computing system receives platform performance data for a plurality of advertisements from one or more advertising platforms via their APIs. The platform performance data includes metrics like CPM, CTR, CPC, and optionally CPR.

At step 210, the computing system receives website performance data for the advertisements from a website analytics platform, also via API integration. The website performance data includes metrics such as page-view, session, add-to-cart, and optionally bounce rate, average session duration and other so-called micro-conversions defining the value of a website visit caused by the ad.

The method proceeds to step 220, where the computing system computes a normalized score for each advertisement based on the platform and website performance data using machine learning and stochastic algorithms implemented with libraries like scikit-learn. The normalized score is on a scale from 0 to 100. The computation can involve determining percentile ranks for each metric relative to a peer group and calculating a weighted average of the percentile ranks.

At step 230, the computing system defines a portfolio of advertisements based on the normalized scores, storing the portfolio data in a database. The portfolio definition can optionally consider a configurable lookback window of time. The portfolio is defined by a peer group and includes all campaigns and ad sets (each containing one or more advertisements) that belong to the peer group such as the same country or using the same landing page.

Step 240 involves comparing the normalized score of each ad in the portfolio to a peer group of ads within the portfolio to determine relative performance, using statistical methods.

At step 250, the computing system provides one or more recommendations for optimizing the portfolio based on the relative performance analysis, displayed on an interactive web dashboard. The recommendations can include identifying low-performing ads for removal, evaluating overall portfolio performance against other ad portfolios, suggesting budget allocation adjustments, and aggregating scores and recommendations by various attributes like campaign, ad set, creative, region, or landing page.

The method concludes at step 260. The steps of the method may be repeated periodically or on-demand to continuously monitor and optimize the advertising portfolio, with the results accessible via API for integration into other business intelligence systems.

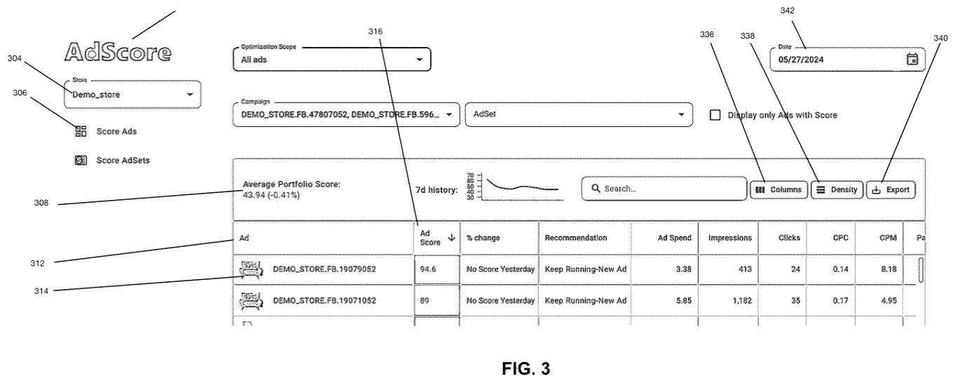

FIG. 3 illustrates an exemplary user interface 300 for managing and optimizing a portfolio of digital advertisements 124 based on normalized scores 122 computed from platform performance data 132 and website performance data 142. The user interface 300 is displayed on a web-based dashboard 128 that may be implemented using web application frameworks such as React, Angular, or Vue. js.

The user interface 300 prominently displays the AdScore branding 302 at the top of the page to clearly identify the application and set the context for the user. Below the branding, a store dropdown 304 allows users to select a specific store or advertising campaign to analyze. For example, if the system is being used to optimize ads for an e-commerce website built on Shopify, the store dropdown 304 may list the different Shopify stores managed by the user. Adjacent to the store dropdown 304 is an ad set dropdown 306 that enables users to select specific ad groups or ad sets within the selected campaign, providing a granular level of analysis.

At the center top of the user interface 300, an average portfolio score 308 is displayed, indicating the overall performance of the selected ad portfolio. In the example shown, the average portfolio score is 43.94, with a slight decline of 0.41% over the last week. This score is dynamically computed based on the normalized scores 122 of the individual ads in the portfolio. A graph icon 310 next to the score visually represents the trend in portfolio performance over time, allowing users to quickly assess changes. The graph may be rendered using charting libraries like Chart. js or D3.js.

Below the average portfolio score 308, a table 312 lists the individual advertisements in the selected portfolio. Each ad is identified by a unique identifier 314, such as an ad ID assigned by the advertising platform (e.g., Google Ads, Facebook Ads). The table also includes columns comprising the ad score, percentage change, recommendation, ad spend, impressions, clicks, CPC (cost-per-click), and CPM (cost-per-mille), or cost per thousand impressions). These metrics provide a comprehensive view of each ad's performance and are retrieved from the platform performance data 132.

The ad score 316 is a normalized score between 0 and 100 that represents the ad's overall performance relative to other ads in the portfolio. It is computed based on metrics such as click-through rate (CTR), conversion rate, and engagement rate, which are normalized using techniques like min-max scaling or z-score normalization. The percentage change 318 indicates how the ad's score has changed over a given time period (e.g., the last 7 days), highlighting recent performance trends.

The recommendation column 320 provides actionable suggestions for each ad based on its performance. For example, if an ad has a high score and a positive percentage change, the recommendation may be “Keep Running” or “Increase Budget”. Conversely, if an ad has a low score and a negative percentage change, the recommendation may be “Pause Ad” or “Optimize Targeting”. These recommendations are generated by applying predefined rules or machine learning algorithms to the ad's performance data.

The user interface 300 also provides options to customize the displayed data. A columns button 336 enables users to select which columns are visible in the ad table, allowing them to focus on the metrics that matter most to their analysis. A density button 338 adjusts the spacing between table rows, providing a more compact or expanded view as needed. An export button 340 allows users to download the ad performance data in formats like CSV or Excel for further analysis or reporting.

Finally, a date selector 342 in the upper right corner of the user interface 300 enables users to filter the displayed data based on a specific date range. This ensures that the analysis reflects the most relevant and up-to-date information.

The user interface 300 is powered by a computing system 100 that includes a processor 110 and memory 120. The computing system 100 interfaces with various advertising platforms 130 (e.g., Google Ads, Facebook Ads, LinkedIn Ads) via their respective APIs to retrieve platform performance data 132. This data includes metrics such as CPM, CTR, CPC, and optionally CPR (cost-per-result).

In addition to the advertising platforms 130, the computing system 100 also interfaces with website analytics platforms 140 (e.g., Google Analytics, Adobe Analytics) to retrieve website performance data 142. This data includes metrics like page views, sessions, add-to-carts, bounce rate, and session duration, which provide insights into how users interact with the website after clicking on an ad.

### Example Score Calculation

The present invention provides a method for calculating normalized scores for advertisements based on various performance metrics. The data used for the ad performance scoring model includes ad performance data at the platform and website/storefront level, consisting of ad id, clicks, impressions, session minutes, aggregated by a time interval such as day.

The method defines an AssetAggregation, which represents the asset or combination of asset and properties that receives a differentiating score. For example, AdDate means each ad gets a score for each date, while AdSetDate means each ad set gets a score for each date. The method also defines a PeerGroupAggregation, which represents the reference against which the asset score is compared. StoreDate means the reference is all ads to one entire webpage/store at a certain day, while StoreCountryDate means all ads to the webpage separate per country at a certain day. The AssetAggregation and PeerGroupAggregation together define the AggregationSet for which the score is computed.

In some embodiments the method offers flexibility in defining the AggregationSet by allowing various combinations of AssetAggregation and PeerGroupAggregation. In some embodiments, other AssetAggregation options may include the creative or the landing page. For example, AdCreativeDate means all ads with the same creative get a score for each date. The PeerGroupAggregation in this case could be AdLandingPageDate, meaning all ads with the same landing page are compared against each other. The combination of AssetAggregation and PeerGroupAggregation defines the AggregationSet, such as AdCreativeDate/StoreLandingPageDate. Furthermore, the aggregation time can be changed to hour, week, or month, providing granular control over the scoring process. Eventually, the aggregations are only limited by the dimensions in the data model that can serve as aggregations to define marketing assets to be scored or compared in a peer group.

For the Click-Through Rate (CTR) as core component of the total score each day, the score component, which is an engagement score, is calculated based on the maximum, minimum, and average CTR observed within a look-back window, typically 14 days. Within this window, the ad with the lowest CTR defines the 0 score, while the ad with the highest CTR defines the 100 score. The average CTR of the entire portfolio is calculated, and the moving average is set to always represent a score of 50. Thus, an ad or ad set achieving this moving average CTR is considered to be performing at an average level. An outlier analysis is applied to avoid making outliers define the 100 and 0 scores, which would compress the scores of average performing ads.

It is important to note that the scores are relative and dynamic, reflecting changes within the ad portfolio. For example, if a new ad achieves a higher CTR than the current maximum, this ad resets the maximum CTR value to 100 for the scoring period. Conversely, a new low-performing ad might reset the minimum CTR value to 0. Similarly, the average CTR can shift due to these new entries or day-to-day variations in ad performance, affecting the scores of all ads relative to these benchmarks.

Similarly, cost-based scores such as Cost Per Click (CPC) are also subject to dynamic adjustments. The CPC score adjusts to reflect market price trends within the platform auction systems. If the average cost per ad, measured by the CPM value in the market, increases or decreases significantly during the look-back period, the cost-based scores are adjusted to reflect these changes, ensuring that the ad scoring remains comparable in the lookback window in a fluctuating market environment.

This scoring mechanism allows for a nuanced and dynamic evaluation of ad performance, accounting for both absolute metrics and relative changes within the ad portfolio. By continuously updating the scores based on the latest data and using a weighing model to compute the total score with components like CTR, CPC or CPPV, the system ensures that the ad portfolio is optimized in real-time, responding to both internal performance shifts and external market conditions

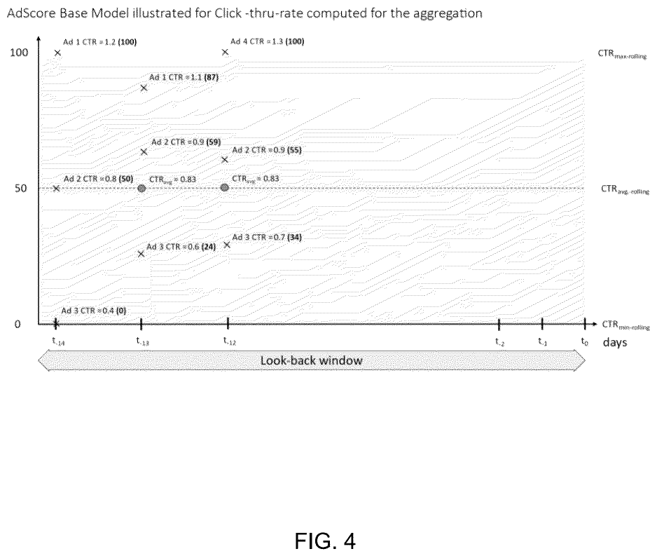

FIG. 4 graphically represents the computation of CTR scores over a look-back window. In this figure, various ads are plotted based on their respective CTR values at different points within the window. At t-14, Ad 1 has a CTR of 1.2, corresponding to a normalized score of 100, while Ad 2 has a CTR of 0.8, corresponding to a score of 50 as it is the average of Ad 1, Ad 2 and Ad 3. At t-13, Ad 1's CTR decreases to 1.1 (score 87), Ad 2's CTR increases to 0.9 (score 59), and a new Ad 3 is introduced with a CTR of 0.6 (score 24). The average CTR at t-13 is 0.83, corresponding to a score of 50. At t-12, a new Ad 4 achieves the highest CTR of 1.3 (score 100), while Ad 2 maintains a CTR of 0.9 (score 55), and Ad 3 slightly improves to a CTR of 0.7 (score 34). The average CTR remains at 0.83 (score 50). This visual representation helps to clarify the dynamic nature of the scoring process, illustrating how the introduction of new ads or changes in CTR values can shift the scoring benchmarks (max, min, and average) over the selected look-back period.

The scoring mechanism described above can be applied to various levels of aggregation, depending on the specific needs and goals of the analysis. For example, if the AssetAggregation is set to Creative, the CTR is calculated for all ads having the same creative, and the score calculation follows the same process as described for individual ads. This allows for a comparative evaluation of the performance of different ad creatives within the portfolio.

Furthermore, the PeerGroupAggregation can be adjusted to focus on specific subsets of the ad portfolio, such as ads served in a particular country or region. In this case, each country or region would have its own portfolio of ads for the score calculation, as depicted in FIG. 4. This enables a more granular analysis of ad performance, taking into account regional variations in user behavior and market conditions.

For example, if the PeerGroupAggregation is set to StoreCountryDate instead of StoreDate, the scoring process would be applied separately for each country, using the country-specific ad portfolio as the reference for calculating the maximum, minimum, and average CTR values. This allows for a more nuanced understanding of how ads are performing relative to their peers within each geographic context.

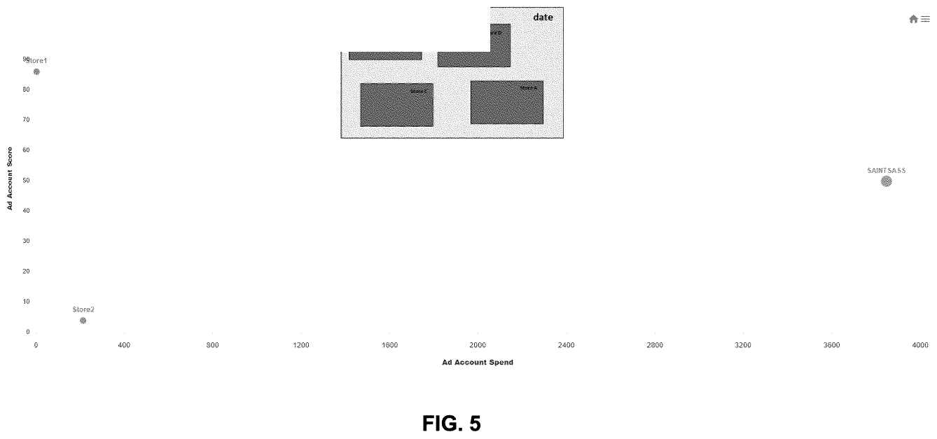

FIG. 5 illustrates the relationship between Ad Account Spend and Ad Account Score for various stores, enabling benchmarking and comparative analysis. Store 1 has an Ad Account Spend of 50 currency units and an Ad Account Score of 85, while Store 2 has an Ad Account Spend of 250 and an Ad Account Score of 4. The store owner sees only their own store, Saint Saas, which has the highest Ad Account Spend at 3700 currency units and an Ad Account Score of 50. This graph demonstrates how the AdScore model can provide insights into the performance of ad accounts across different stores, helping to optimize ad spend and improve overall ad effectiveness. Peer group selection for stores can be done based on characteristics such as store size, market segment, or geographic region, ensuring a fair and relevant comparison. By leveraging the AdScore model for benchmarking, store owners and marketers can make data-driven decisions to optimize their ad strategies and stay competitive in their respective markets.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for managing and optimizing a portfolio of digital advertisements, the method comprising:
receiving, by a computing system, platform performance data for a plurality of advertisements from one or more advertising platforms, the platform performance data comprising a CPM, a CTR, and a CPC for each of the plurality of advertisements;
receiving, by the computing system, website performance data for the plurality of advertisements from a website analytics platform, the website performance data comprising page-views, sessions, and add-to-carts for each of the plurality of advertisements;
computing, by the computing system, a normalized score for each of the plurality of advertisements based on the platform performance data and the website performance data, wherein the normalized score is on a scale from 0 to 100 each;
defining, by the computing system, a portfolio of advertisements based on the normalized scores of the plurality of advertisements;
comparing, by the computing system, the normalized score of each advertisement in the portfolio to a peer group of advertisements within the portfolio to determine a relative performance of each advertisement; and
providing, by the computing system, one or more recommendations for optimizing the portfolio of advertisements based on the relative performance of each advertisement in the portfolio.

2. The method of claim 1, wherein the platform performance data further comprises a cost-per-result (CPR) for each of the plurality of advertisements.

3. The method of claim 1, wherein the website performance data further comprises a bounce rate and session duration for each of the plurality of advertisements.

4. The method of claim 1, wherein computing the normalized score for each advertisement comprises:
determining a normalized rank for each of the CPM, CTR, CPC, cost-per-page-view, cost-per-session, and cost-per-add-to-cart relative to the peer group of advertisements; and
calculating a weighted average of the determined percentile ranks.

5. The method of claim 4, wherein the weighted average applies predetermined weights to each of the CPM, CTR, CPC, cost-per-page-view, cost-per-session, and cost-per-add-to-cart based on a predictive contribution to a conversion.

6. The method of claim 1, wherein the portfolio of advertisements is defined based on a lookback window of time.

7. The method of claim 1, wherein the one or more recommendations comprise:
identifying one or more advertisements from the portfolio that fall below a threshold normalized score; and
suggesting removal of the identified one or more advertisements from the portfolio.

8. The method of claim 1, wherein the one or more recommendations comprise:
determining an overall performance score for the portfolio of advertisements based on an average of the normalized scores; and
evaluating the overall performance score against performance benchmarks.

9. The method of claim 1, wherein the one or more recommendations comprise suggested adjustments to a budget allocation between advertisements in the portfolio based on the relative performance.

10. The method of claim 1, further comprising:
aggregating the normalized scores by one or more attributes selected from: a campaign, an ad set, a creative, a region, and a landing page; and
providing the one or more recommendations at an aggregated level.

11. The method of claim 1, wherein computing the normalized score for each advertisement further comprises:
determining a weight for each of the platform performance data and the website performance data based on a contribution to a conversion and a data quality; and
applying the determined weights when combining the platform performance data and the website performance data to compute the normalized score.

12. The method of claim 1, wherein the portfolio of advertisements comprises one or more ad sets, each ad set containing one or more advertisements.

13. A system for managing and optimizing a portfolio of digital advertisements, the system comprising:
a computing system comprising a processor and a memory storing instructions that, when executed by the processor, cause the computing system to:
receive platform performance data for a plurality of advertisements from one or more advertising platforms, the platform performance data comprising a CPM, a CTR, and a CPC for each of the plurality of advertisements;
receive website performance data for the plurality of advertisements from a website analytics platform, the website performance data including at least one of a cost-per-page-view, a cost-per-session, and a cost-per-add-to-cart for each of the plurality of advertisements;
compute a normalized score for each of the plurality of advertisements based on the platform performance data and the website performance data, wherein the normalized score is on a scale from 0 to 100;
define a portfolio of advertisements based on the normalized scores of the plurality of advertisements;
compare the normalized score of each advertisement in the portfolio to a peer group of advertisements within the portfolio to determine a relative performance of each advertisement; and
provide one or more recommendations for optimizing the portfolio of advertisements based on the relative performance of each advertisement in the portfolio.

14. The system of claim 13, wherein the platform performance data further comprises a CPR for each of the plurality of advertisements.

15. The system of claim 13, wherein the website performance data further comprises a bounce rate and an average session duration for each of the plurality of advertisements.

16. The system of claim 13, wherein computing the normalized score for each advertisement comprises:
determining a percentile rank for each of the CPM, CTR, CPC, cost-per-page-view, cost-per-session, and cost-per-add-to-cart relative to the peer group of advertisements; and
calculating a weighted average of the determined percentile ranks.

17. The system of claim 16, wherein the weighted average applies predetermined weights to each of the CPM, CTR, CPC, cost-per-page-view, cost-per-session, and cost-per-add-to-cart based on a predictive contribution to a conversion.

18. The system of claim 13, wherein the portfolio of advertisements is defined based on a lookback window of time.

19. The system of claim 13, wherein the one or more recommendations comprise:
identifying one or more advertisements from the portfolio that fall below a threshold normalized score; and
suggesting removal of the identified one or more advertisements from the portfolio.

20. The system of claim 13, wherein the one or more recommendations comprise:
determining an overall performance score for the portfolio of advertisements based on an average of the normalized scores; and
evaluating the overall performance score against performance benchmarks.

21. The system of claim 13, wherein the one or more recommendations comprise suggested adjustments to a budget allocation between advertisements in the portfolio based on the relative performance.

22. The system of claim 13, wherein the instructions further cause the computing system to:
aggregate the normalized scores by one or more attributes selected from: a campaign, an ad set, a creative, a region, and a landing page; and
provide the one or more recommendations at an aggregated level.

23. The system of claim 13, wherein computing the normalized score for each advertisement further comprises:
determining a weight for each of the platform performance data and the website performance data based on a contribution to a conversion and a data quality; and
applying the determined weights when combining the platform performance data and the website performance data to compute the normalized score.

24. The system of claim 13, wherein the portfolio of advertisements comprises one or more ad sets, each ad set containing one or more advertisements.
